(19) United States
(12) Patent Application Publication
(10) Pub. No.: US 2008/0216072 A1
(43) Pub. Date: Sep. 4, 2008

(54) TRANSITION BETWEEN PROCESS STEPS

(75) Inventors: Andreas Schneider, Bobenheim-Roxheim (DE); Igor Kalenderian, Heidelberg (DE); Renzo Colle, Stutensee (DE)

Correspondence Address: FISH & RICHARDSON, P.C., PO BOX 1022, MINNEAPOLIS, MN, 55440-1022, US

(73) Assignee: SAP AG

(21) Appl. No.: 11/873,083

(22) Filed: Oct. 16, 2007

Related U.S. Application Data
(60) Provisional application No. 60/852,433, filed on Oct. 16, 2006.

(51) Int. Cl. G06F 9/46

(52) U.S. Cl. 718/100

(57) ABSTRACT

Among other disclosure, a data flow is an entity that completely or substantially encapsulates all or substantially all aspects of a flow of data from a preceding object instance part into a succeeding object instance part. A set of several single flows of data can provide the complete flow of data of an entire process step.

### CROSS-REFERENCE TO RELATED APPLICATIONS

This document relates to and claims priority from:

U.S. Provisional Patent Application 60/852,433, filed Oct. 16, 2006 and entitled “Data flow”; and

U.S. patent application Ser. No. 11/148,245, filed Jun. 9, 2005 and entitled “Controlling data transition between business processes in a computer application”.

The contents of each of the above applications is incorporated herein by reference.

### TECHNICAL FIELD

This document relates to a data flow.

### BACKGROUND

Enterprise information technology (IT) systems often are used to manage and process business data. To do so, a business enterprise may use various application programs running on one or more enterprise IT systems. Application programs may be used to process business transactions, such as taking and fulfilling customer orders, providing supply chain and inventory management, performing human resource management functions, and performing financial management functions. Application programs also may be used for analyzing data, including analyzing data obtained through transaction processing systems. In many cases, application programs used by a business enterprise are developed by a commercial software developer for sale to, and use by, many business enterprises.

An application program may be designed to meet the specific requirements of the environment in which the application program is operating. Some commercial application programs may be designed for use by many business enterprises that are in a particular industry or in a particular geographic region. In some cases, a more-generalized commercial application program may be modified for more specialized use by many business enterprises. Such modifications may be performed by the same business enterprise that developed the more-generalized commercial application program, or such modifications may be performed by a different business enterprise, which may be referred to as a “business partner” of the business enterprise that developed the more-generalized commercial application program. In some cases, modifications may be made to the application program to meet the specific requirements of business enterprises in a particular industry or a particular geographic region, or to meet the specific requirements of a particular business enterprise or a particular department in a business enterprise. Examples of such modification include customization of the data model, the process model, or the user interface of the application. Modification of an application program may require knowledge of the data model, the process model, and/or the user interface of the application program. Modification of an application program also may require knowledge of programming techniques used to develop the application program.

Business processes may be subdivided into several phases or steps of process execution following each other according to some rules. Examples of this include planning steps, execution steps, finalization steps, etc. in logistic processes. To be able to model such business process steps at design time and to automatically implement and execute them at runtime it is often required to describe how parts of preceding objects involved in the process step are distributed to succeeding ones (splitting and merging, m:n relations) as well as how data is copied/moved from the predecessor(s) to the successor(s) (flows of data). In principle, the number of different types of preceding object instances involved in such a step and the number of different types of succeeding object instances can be unlimited (1 or many). Covering all aspects of modeling and executing a process step can include covering its first execution (creation of succeeding object instances) as well as all further executions (change, deletion of succeeding object instances) during the lifetime of a process.

### SUMMARY

The invention relates to data flow.

In some aspects, methods and systems are provided for modeling business process steps in a system. For example, such aspects can provide for modeling of all aspects of the flow of data from the predecessor(s) to the successor(s) steps. A single or multiple predecessor steps can be modeled to transition into a single or multiple successor steps. Split/merge rules can be provided to be associated with process steps such that, at runtime, business objects are split and/or merged according to the rules. Any or all aspects described herein can be part of a method or system.

In some aspects, a transaction service is provided to interact with business objects. The service can include any or all of a management service, a splitting and/or merging service, and a data transfer service. Any or all aspects described herein can be part of a transaction service.

In some aspects, a data flow is an entity that completely or substantially encapsulates all or substantially all aspects of a flow of data from a preceding object instance part into a succeeding object instance part. A set of several single flows of data can provide the complete flow of data of an entire process step. Any or all aspects described herein can be part of a data flow.

Implementations can provide any, all or none of the following advantages. Modeling of business processes can be improved. Data flow between instances in a process can be improved. Transitions between steps or objects in a business process can be improved. Configuration and/or operation of enterprise business systems can be improved. A modeling process can be provided where split/merge rules and data flow rules are separate and/or independent. Providing predefined business content that can be included in a computer system before delivery to a customer who will configure the system according to the customer's needs. Providing that a data flow is defined using an underlying structure and not by names of nodes involved in the transition. Providing product flexibility because only some settings are changed; providing product transparency because a user can see the relevant information; and providing product stability because everything is managed in a common place.

The details of one or more embodiments are set forth in the accompanying drawings and the description below. Other features and advantages will be apparent from the description and drawings, and from the claims.

### DESCRIPTION OF DRAWINGS

FIG. 1 shows an exemplary block diagram of a transition service for business objects.

FIG. 2 schematically shows business process steps.

FIG. 3 shows an exemplary user interface for defining a data flow.

FIG. 4 shows another exemplary user interface for defining a data flow.

FIG. 5 shows an overview of a class diagram for a runtime of a transition service.

FIG. 6 shows an exemplary block diagram of interfaces of a transition service for business objects.

FIG. 7 shows an exemplary sequence diagram of an instantiation of a transition service for business objects.

FIG. 8 shows an exemplary sequence diagram of an execution of a transition service for business objects.

FIG. 9 shows an exemplary profile for a transition service for business objects.

FIG. 10 shows an exemplary sequence diagram for executing a split/merge service of a transition service for business objects.

FIG. 11 shows an exemplary structure of a split/merge rule.

FIGS. 12 and 13 show an exemplary sequence diagram for a data transfer service of a transition service for business objects.

FIG. 14 shows an exemplary structure of a data flow.

FIG. 15 shows an exemplary package structure of a transition service for business objects.

FIG. 16 shows an exemplary configuration of a transition service for business objects.

FIG. 17 shows an exemplary integration of a configuration of a transition service for business objects with an easy enhancement work bench.

FIG. 18 shows an exemplary block diagram of buffering in a transition service for business objects.

FIG. 19 shows an exemplary business object for a container of a transition service for business objects.

FIG. 20 is a block diagram of a computing system that can be used in connection with computer-implemented methods described in this document.

Like reference symbols in the various drawings indicate like elements.

### DETAILED DESCRIPTION

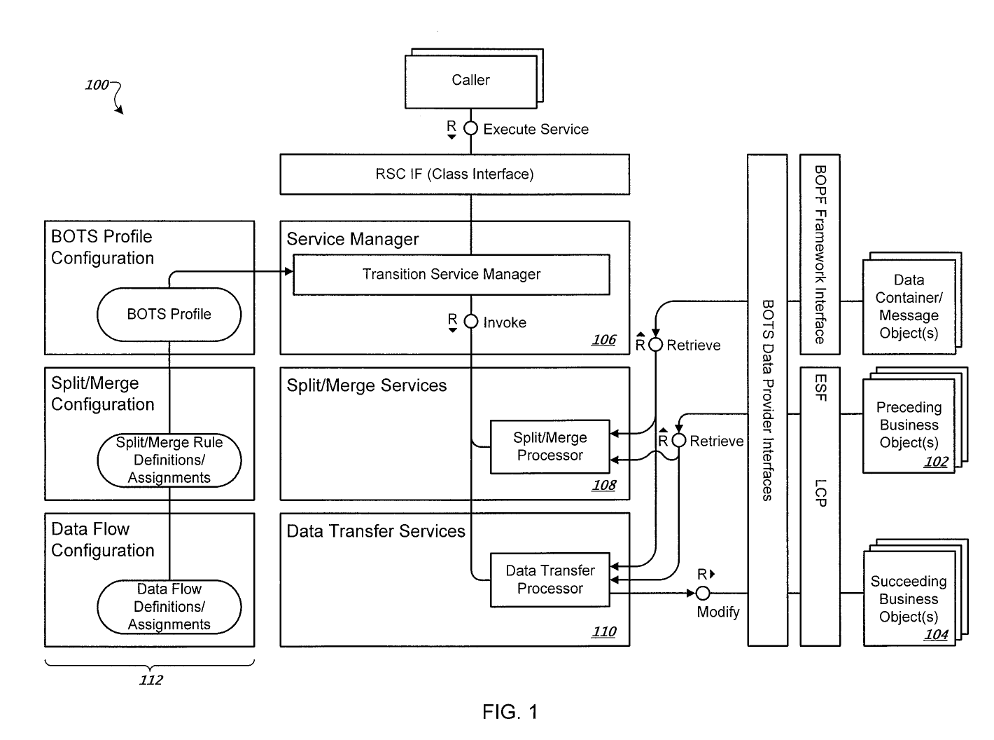

FIG. 1 shows an exemplary block diagram of a transition service 100 for business objects. The service 100 can be used with many types of business objects including, but not limited to, business objects used in enterprise resource planning (ERP) systems and solutions. A business object can represent a specific view on well-defined and outlined business content. The business object can therefore be a representation of a uniquely identifiable business entity described by a structural model, an internal process model, and one or more service interfaces. One or more implemented business processes can operate on business objects.

In some implementations, the service 100 is used with any or all of the business objects (here: BOs) available in products from SAP AG. Examples of such BOs include, but are not limited to: Sales Order, Supplier Invoice, and Outbound Delivery. The exemplary service 100 is therefore referred to as the BO transition service, or BOTS for short. For example, BOTS can provide for modeling of all aspects of the flow of data from predecessor(s) to successor(s) steps in a business process. BOTS is described in the provisional application U.S. 60/852,433, on any or all of pages 1-302 thereof (pages in this provisional application are hereafter referred to thus: pages 1-302). Examples of business scenarios using BOTS include: sell from stock, plan driven procurement (pages 165 et seq.). These or other scenarios can involve outbound delivery components and/or inbound delivery components.

At a high level, BOTS illustrates how a transition can be accomplished between one or more preceding business objects 102 and one or more succeeding business objects 104. BOTS can include a management service 106, a split/merge service 108, and a data transfer service 110. Any or all of these services can be defined by, and performed in accordance with, information included in a configuration 112. In some implementations, each of the services 106-110 has a separate configuration. For example, BOTS can provide one or more data flow entities. A data flow can be an entity that completely or substantially encapsulates all or substantially all aspects of a flow of data from a preceding object instance part into a succeeding object instance part.

The following are examples of using BOTS. The data transfer service 110 can handle issues relating to which data is to be moved and when. For example, the data transfer service can provide execution of a number of data flows based on a result of applying split/merge rules. The split/merge service 108 can handle issues relating to how many instances are to be used. The management service 106 can hold together the processing performed by the other two (and optionally other) services and/or other components. For example, the management service can create class instances, read data and call one or more other services.

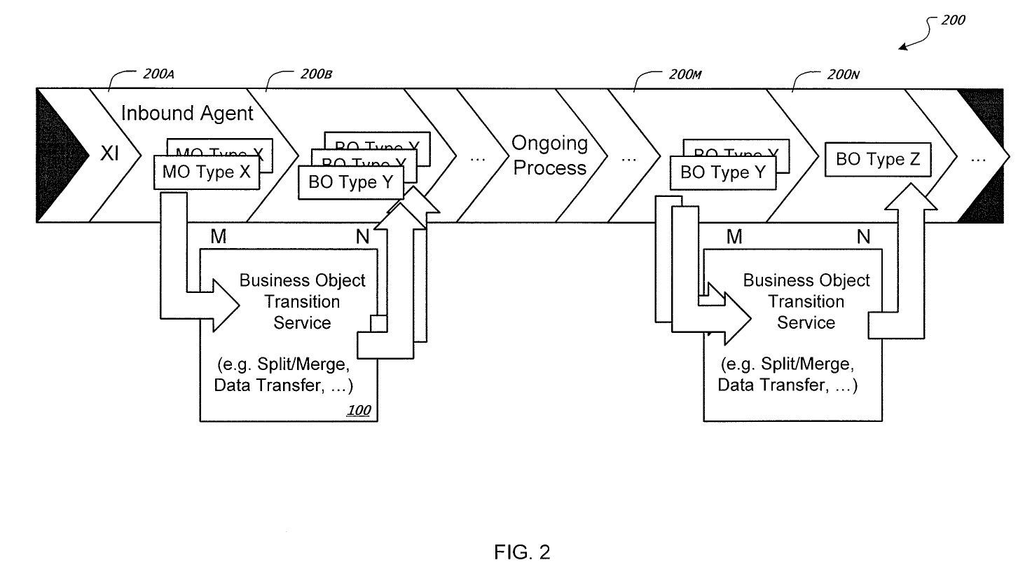

FIG. 2 schematically shows business process steps 200. For example, step 200A relates to message objects (labeled MO Type X) received using an inbound agent, and step 200B relates to business objects (labeled BO Type Y) each of which is a successor to one or more of the business objects in step 200A. For example, the MO Type X objects can be created using data from a message that an inbound agent receives or obtains. The inbound agent can, in some implementations, include ABAP coding for processing inbound messages.

A transition will be performed from the MO Type X objects to the BO Type Y objects. For example, the BOTS 100 can be used. Similarly, the BOTS 100 (or another transition service) can be used to transition from business objects (labeled BO Type Y) in a step 200M to business objects (labeled BO Type Z) in a step 200N. The process that includes the steps 200A,B,M,N can in some implementations include more or fewer process steps.

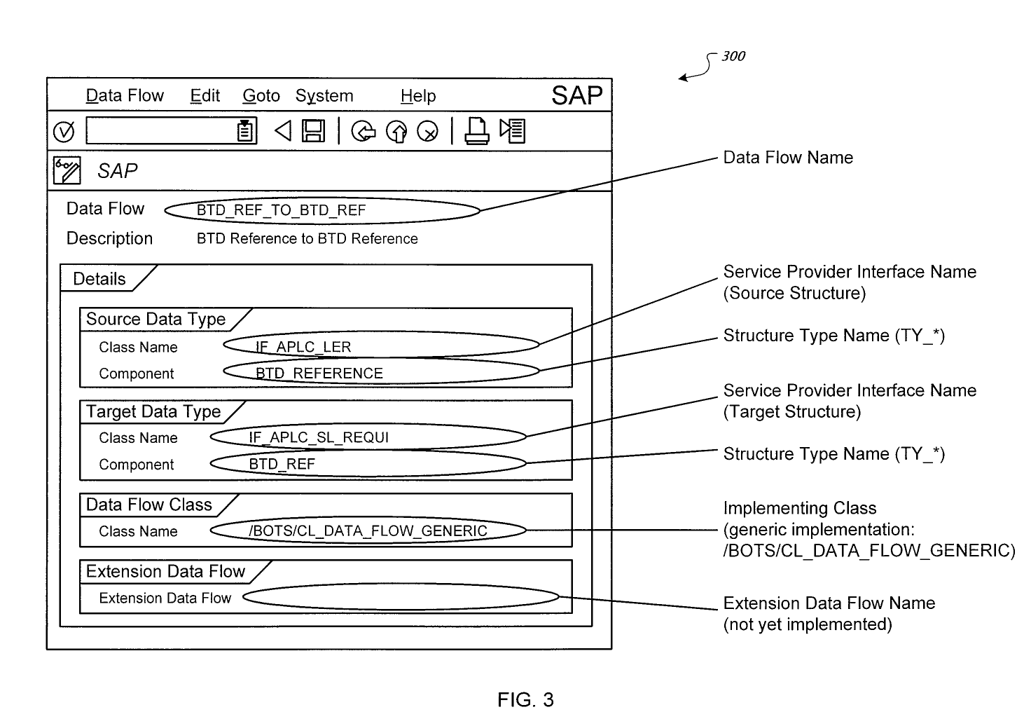

FIG. 3 shows an exemplary user interface 300 for defining a data flow. A data flow can be defined to have a unique identifier, which may be used to refer to it (i.e. to use it in a process step model at design time and to execute it while executing this process step at runtime). The data flow can be modeled separately and can form a part of a bigger flow or process. In some implementations, the data flow refers to the data structure in a particular object (e.g., the data structure of a particular object node) and does not refer to the name of the node. This can make data flows reusable.

A data flow can be defined independently from any object specific concept (such as object names or object node names) and can be based only on data structure information to keep it re-usable. Object specific data flows might have disadvantages if they must be defined several times, also when two or more flows technically perform the same operation (such as copying business partner data).

A data flow can be defined independently from any business process model steps while being capable of use in one or several business process model steps. A business process step can be modeled and executed by another functionality, for example a Business Object Transition Service or Business Process Gate Service as described in pending application U.S. Ser. No. 11/148,245.

A data flow can contain information on one preceding data structure and one succeeding data structure (i.e. their respective technical names) which can be used to generically manipulate them at runtime (i.e. to allocate a typed piece of memory for them and to access their components).

A data flow can contain information on one processing entity (e.g., in SAP implementations, the technical name of an ABAP class which shall be invoked when executing the corresponding data flow). This processing entity can be a specific implementation made to execute exactly one kind of data move, and/or a generic one, which is able to execute several ones, based on further model information. Every processing entity can offer a unified API (e.g., in SAP implementations, implement an ABAP interface), so they can be all invoked the same way at runtime by some processor.

In short, the interface 300 can provide for naming of the data flow being defined, naming a source data type, a target data type, a data flow class, and an extension data flow. For example, the source data type can be identified by naming an interface name of a service provider for the source structure, the target data type by naming an interface name of a service provider for the target structure, and the data flow class by naming an implementing class. The interface 300 does not provide for entering names of nodes in the source and target objects, but rather the types of structure(s) involved. A user such as a developer, a service and/or an application can make input in the interface 300 for defining the data flow. The defined data flow can be stored in the system.

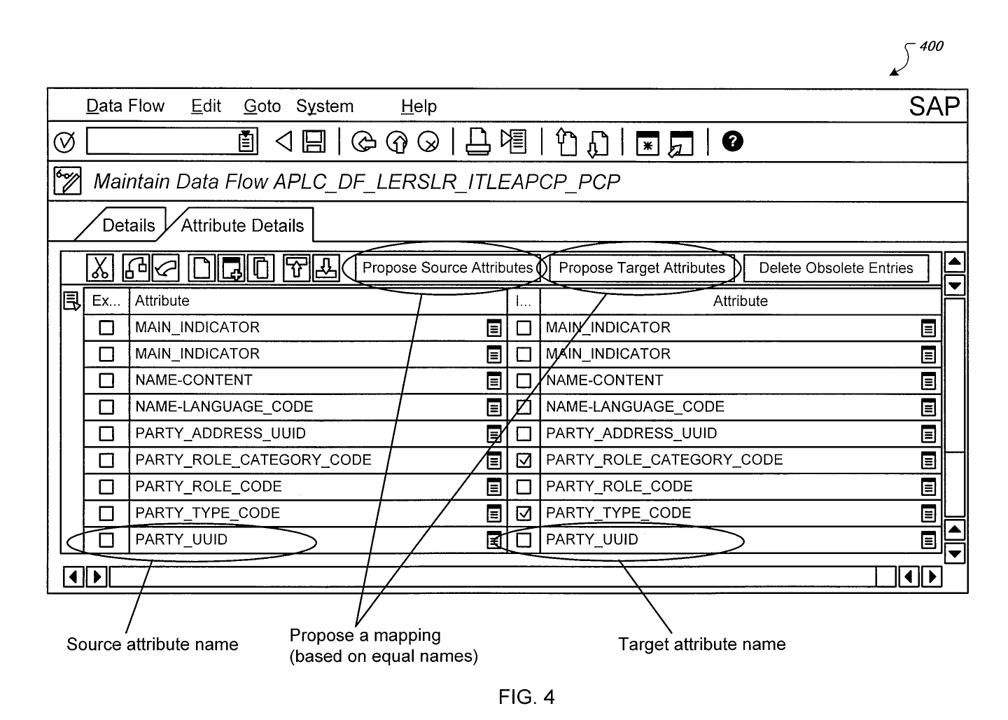

FIG. 4 shows another exemplary user interface 400 for defining a data flow. The interface 400 provides for mapping proposals based on attribute characteristics, such as by looking for identical or equivalent attribute names. For example, the system generating the interface 400 can propose source attributes and/or target attributes, such as upon user request, and if such a proposed mapping is accepted (e.g., by the user or by another entity), one or more field-to-field mappings can be included in the data flow. In some implementations, the user can accept, modify and/or reject any mapping proposed by the system. In this example, the mappings in the user interface 400 define how data will flow from preceding to succeeding node(s) when executed. In some implementations, the interface 400 could also provide for conversion of data in the mapping between any or all of the attributes.

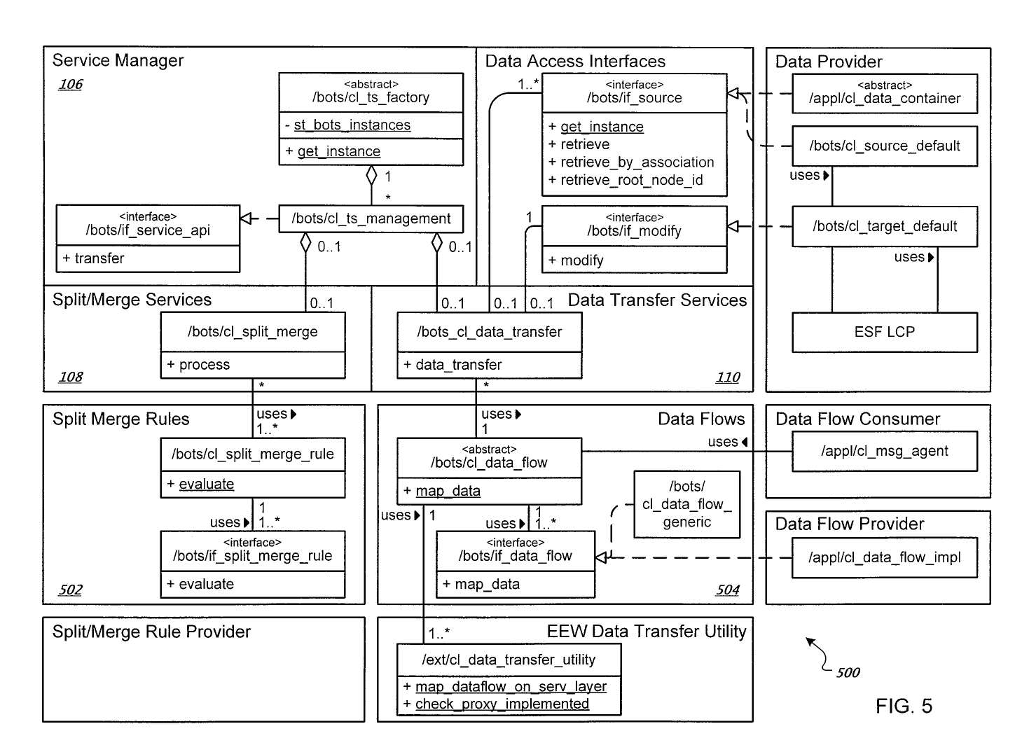

FIG. 5 shows an overview of a class diagram 500 for a runtime of a transition service. Here, the diagram 500 includes the services 106-110. The management service 106 can use one or more data providers, such as through a data access interface. The split/merge services can use split/merge rules 502. In some implementations, the split/merge rules refer to the data structure in a particular object (e.g., the data structure of a particular object node) and does not refer to the name of the node. This can make split/merge rules reusable. The data transfer services can use data flows 504. For example, the class diagram 500 can include any or all features described with regard to BOTS (pages 99-103). The data provider shown in the class diagram represents a preceding BO or MO. A data flow consumer can include any entity that calls a data flow. For example, an outbound agent can call a data flow without invoking the rest of a framework for the business object, such as a BO framework. For the outbound agent, the data flow can provide a useful snapshot of the data that is passed between source and target objects.

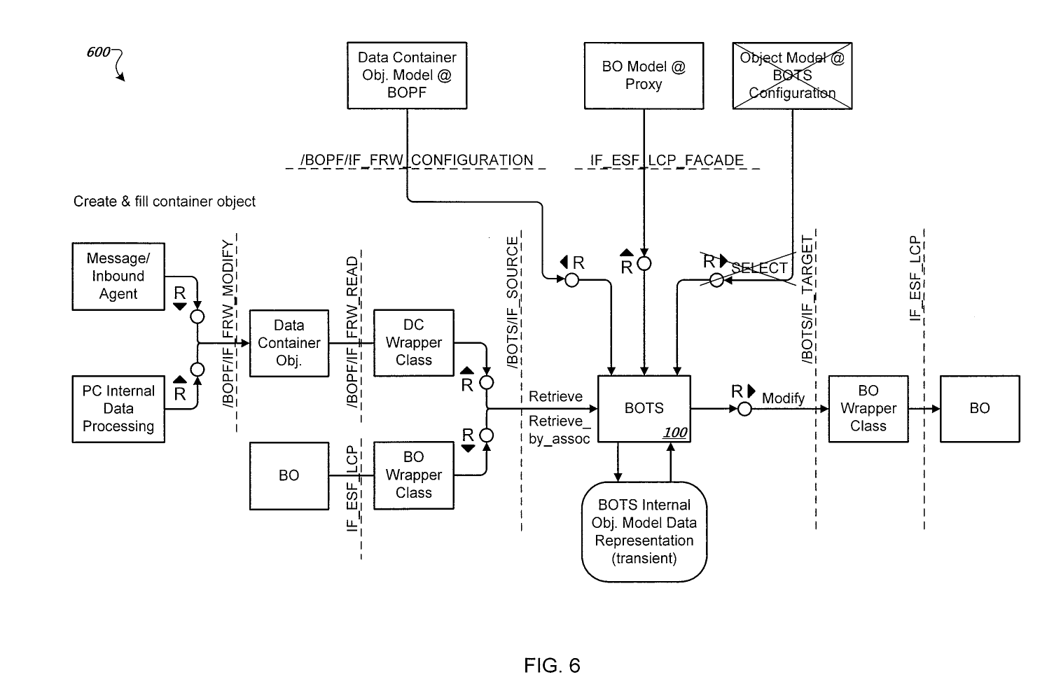

FIG. 6 shows an exemplary block diagram 600 of interfaces of a transition service for business objects. The diagram 600 shows interfaces useable with BOTS 100. A business object on the left side here represents one or more source objects, and a business object on the right side represents one or more target objects. Elements at the top represent aspects of a configuration. In some implementations, the interfaces in diagram 600 can include any or all of the interfaces described with regard to BOTS (pages 147-154).

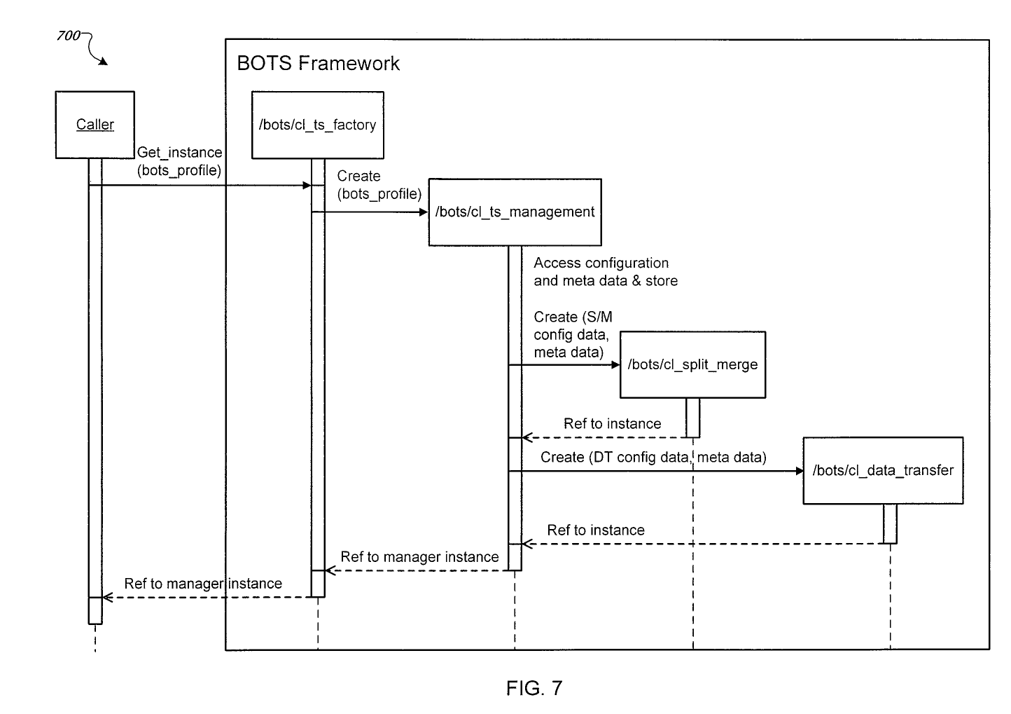

FIG. 7 shows an exemplary sequence diagram 700 of an instantiation of a transition service for business objects. For example, configuration and metadata can be accessed to instantiate the service. Such information can be used for calculating paths for navigating objects structure, to name one example. In a BOTS implementation, this can involve use of management, split/merge and/or data transfer services.

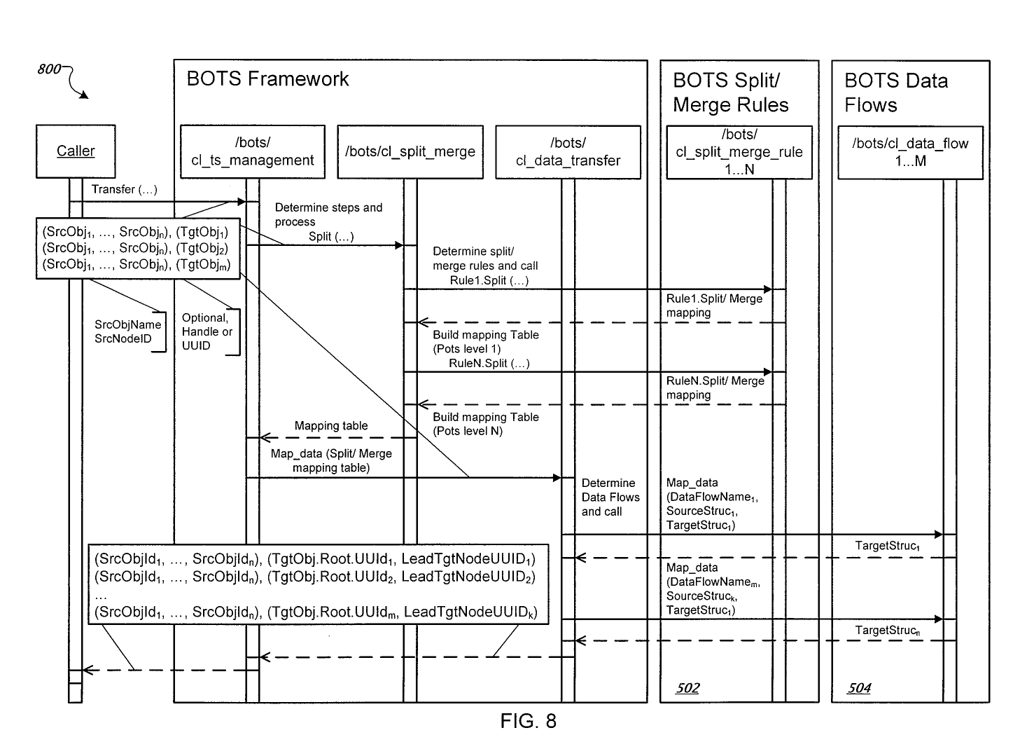

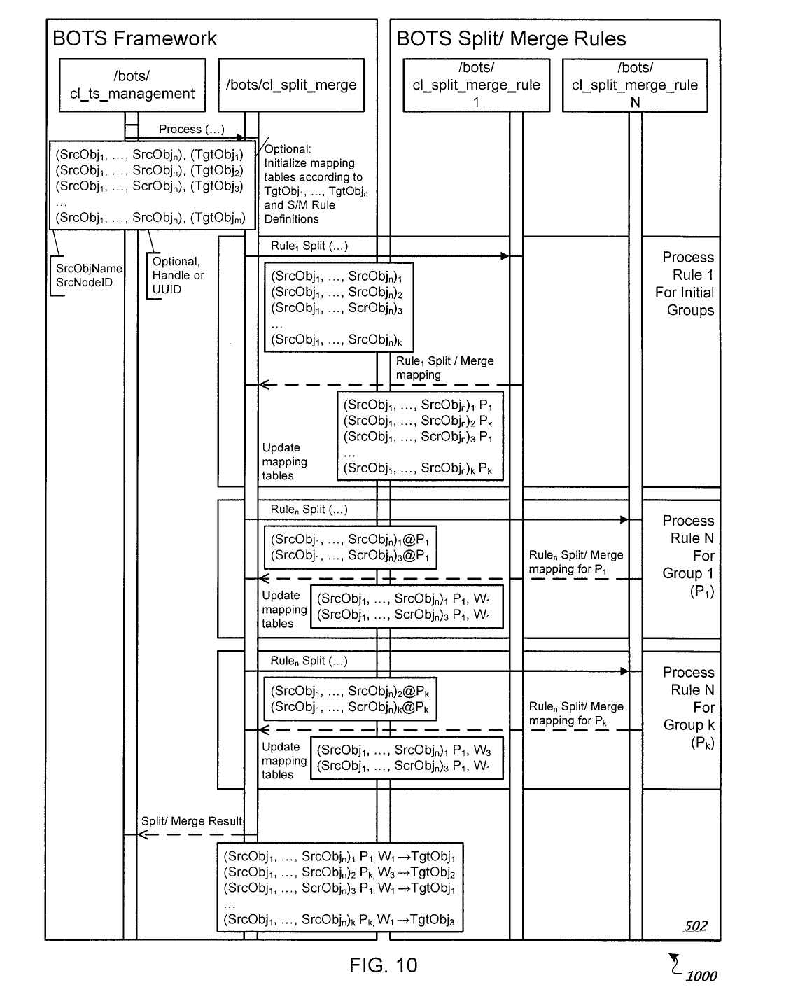

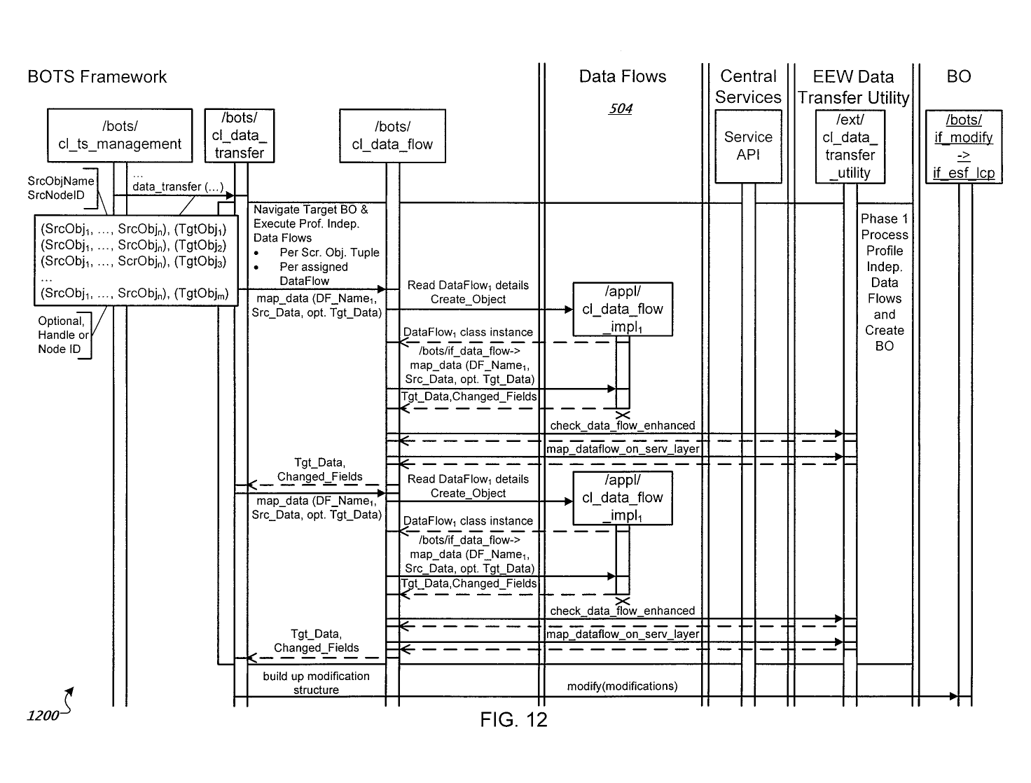

FIG. 8 shows an exemplary sequence diagram 800 of an execution of a transition service for business objects. In a BOTS implementation, sequence diagram 800 can involve use of split/merge rules 502, for example as will be shown and described in FIG. 10 below. In some implementations, split/merge services are provided on an opt-out or opt-in basis. As another example, in a BOTS implementation sequence diagram 800 can involve use of data flows 504, for example as will be shown and described in FIGS. 12-13 below.

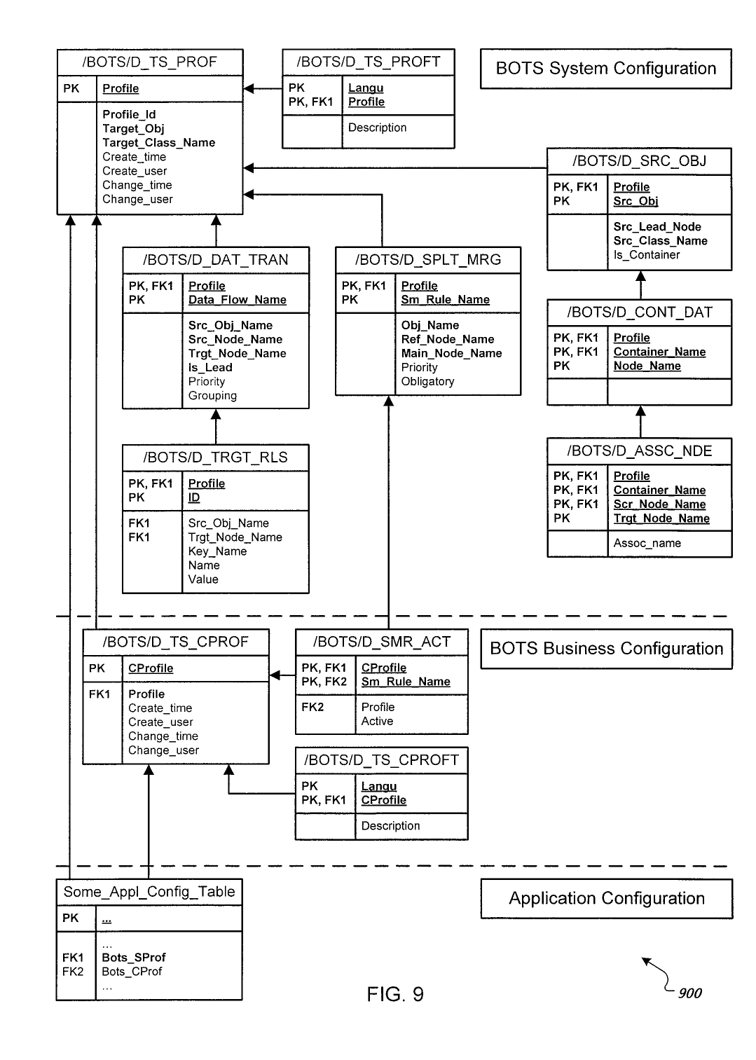

FIG. 9 shows an exemplary profile 900 for a transition service for business objects. Here, the profile 900 includes a data model showing how data is stored. The profile 900 can include components at an application configuration level, at a BOTS business configuration level, and at a BOTS system configuration level. In some implementations, the parts of the profile at the system configuration level and at the application configuration level can be defined by a manufacturer or designer of the system, and a part at the business configuration level can be altered by the system customer. The application configuration level here shows that the application(s) can have some functionality for calling a data flow management service, such as BOTS. The profile can indicate relations between objects and can include or refer to the applicable data flow(s). For example a configuration data model for BOTS can be used with the profile 900 (pages 127 et seq.).

FIG. 10 shows an exemplary sequence diagram 1000 for executing a split/merge service of a transition service for business objects. In a BOTS implementation, sequence diagram 1000 can involve use of split/merge rules 502 using one or more classes and applying rules to one or more groups. For example, with regard to a business object that includes nodes, individual nodes can be placed in particular buckets as part of application of split/merge rules. In some implementations, split/merge rules are joined with each other by a logical AND relation. The diagram 1000 can provide a split/merge result as an output, and such an output can for example be followed by a data flow that it relates to.

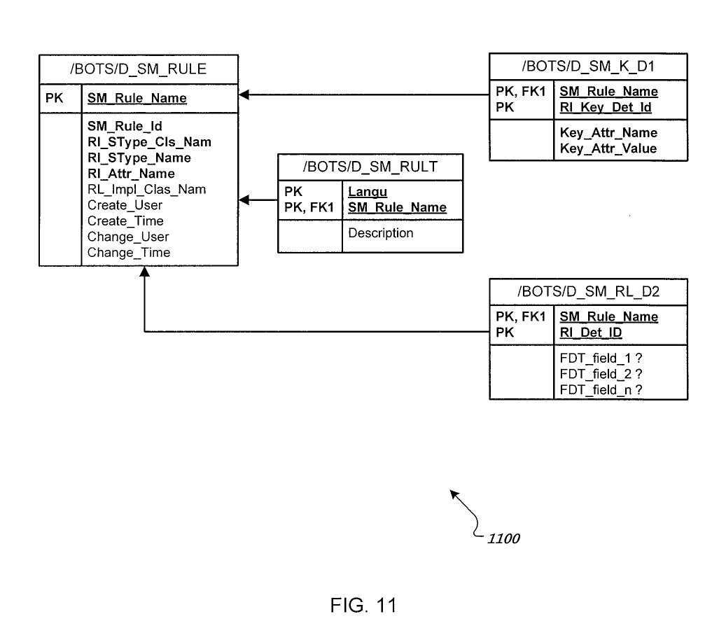

FIG. 11 shows an exemplary database model 1100 showing how a definition of a split/merge rule can be stored. A split/merge rule can be defined using one or more data dictionary tables (pages 140 et seq.).

FIGS. 12 and 13 show an exemplary sequence diagram 1200 for a data transfer service of a transition service for business objects. Here, the sequenced diagram shows how one, multiple or many data flows are executed for a particular step. Foe example, where business objects include nodes, a data flow can be defined for each of the nodes.

In some implementations, the diagram 1200 is executed in at least a first phase and a second phase. The first phase can include processing profile independent data flows and creating one or more business objects. For example, this can involve processing normal data flows and thus directly moving data. The second phase can include processing profile dependent data flows and modifying one or more business objects. For example, this can involve text or an attachment that is maintained by another service, and thus data is not directly moved by the data flow but rather the data flow can encapsulate an underlying service. In BOTS implementations, the diagram 1200 can involve using classes from the services 106-110. An outcome of performing the sequence diagram 1200 can be that a complex table is generated for further processing.

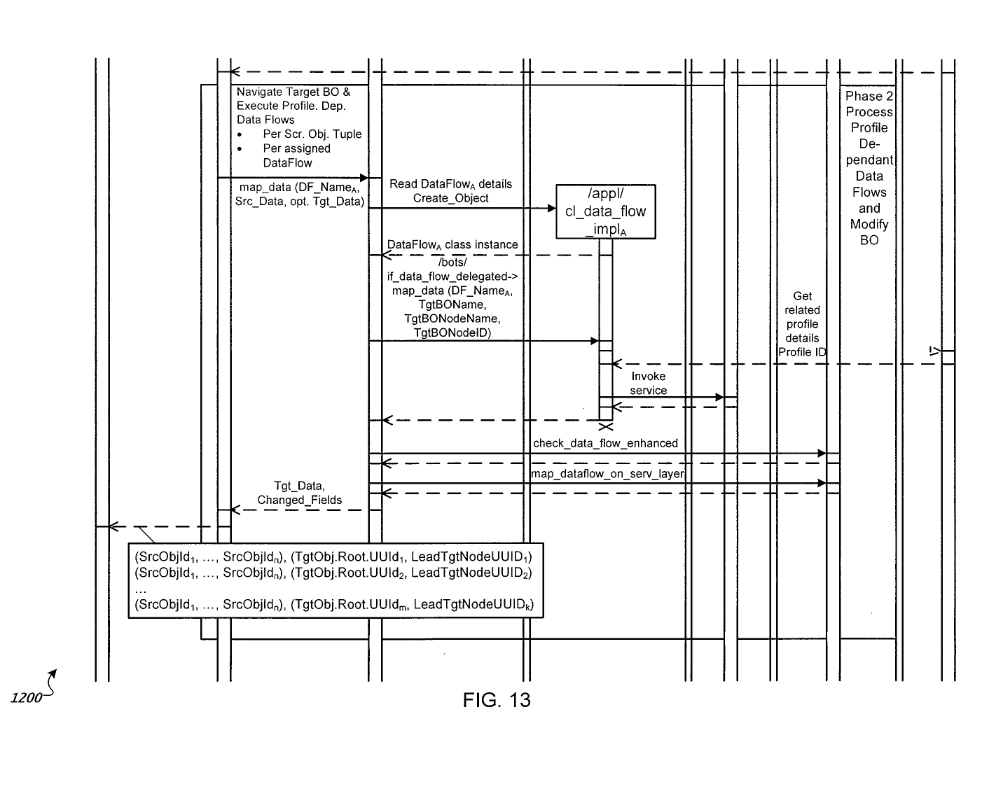

FIG. 14 shows an exemplary database model 1400 for a data flow. The structure 1400 can include a unique identifier for the data flow. The structure 1400 can contain information on at least one preceding and at least one succeeding data structure (e.g., a key of a source or target object). The structure 1400 can contain information on at least one processing entity, such as a specific implementation or a generic implementation. For example, class names of source and/or target types can be defined. For example, data flows can be defined using data dictionary tables (pages 144 et seq.).

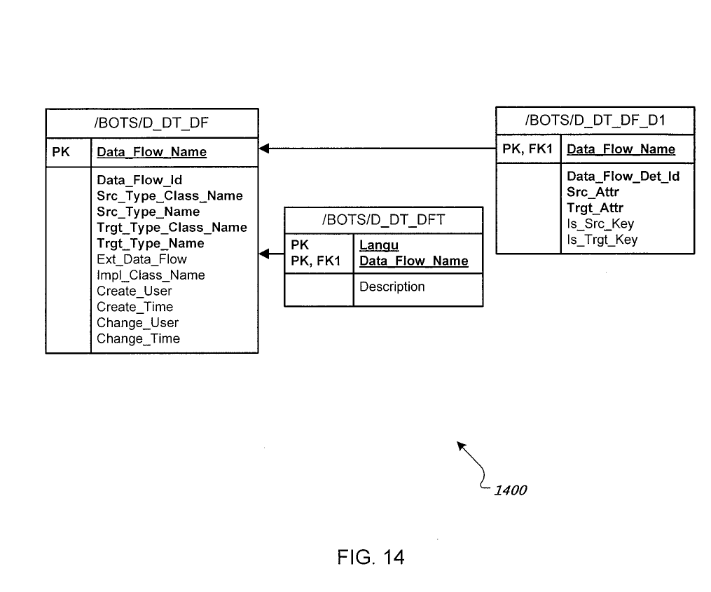

FIG. 15 shows an exemplary package structure 1500 of a transition service for business objects. For example, the structure 1500 can indicate how components delivered to a customer are packaged. In a BOTS implementation, the structure 1500 can include a BOTS package structure (pages 122 et seq.).

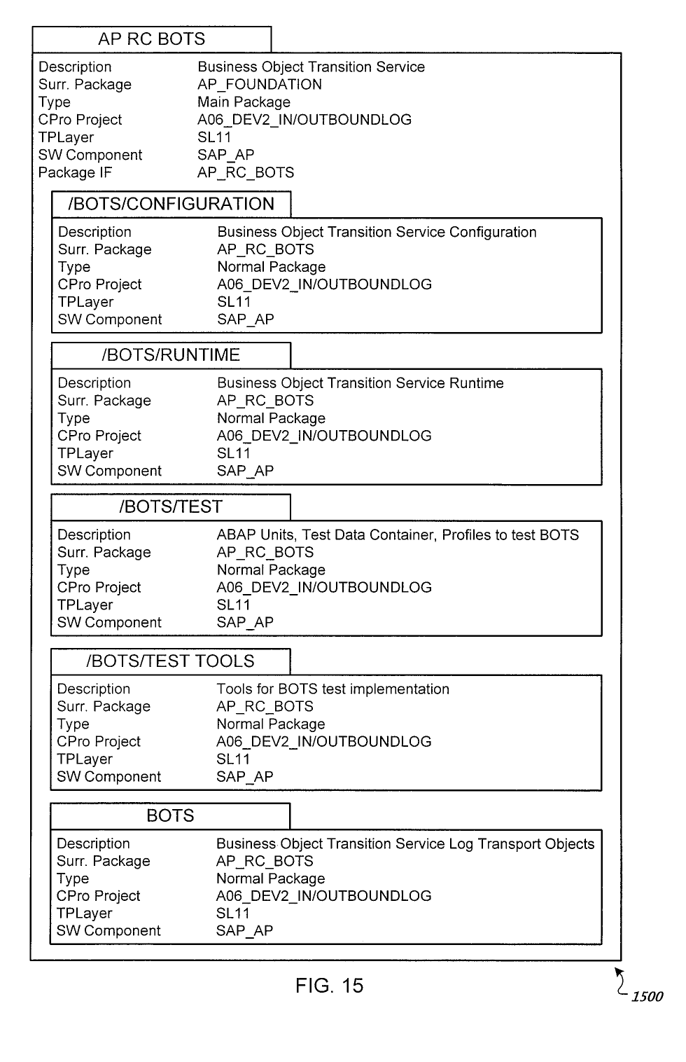

FIG. 16 shows an exemplary configuration 1600 of a transition service for business objects. The structure 1600 can be considered an overview of the contents of FIGS. 9, 11 and 14 mentioned above. The configuration 1600 can include the configuration 112. The configuration 1600 can use the split/merge rules 502 and/or the data flows 504. In some implementations, a BOTS configuration data model can be used (pages 104 et seq.).

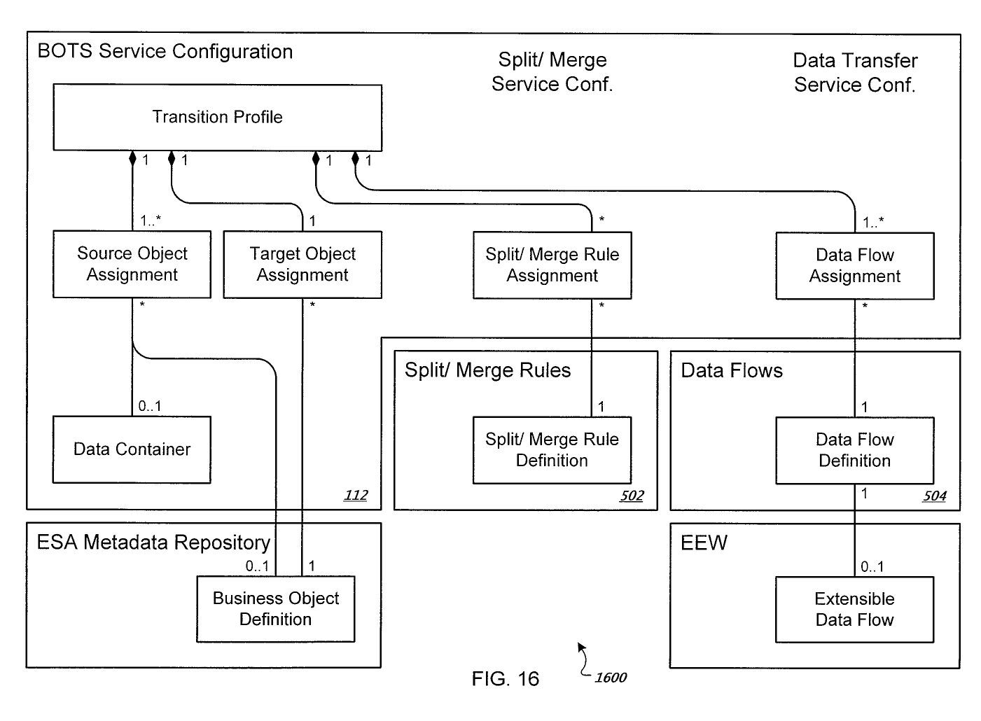

FIG. 17 shows an exemplary integration 1700 of a configuration of a transition service for business objects with an easy enhancement work bench. Foe example, this can illustrate how an external data flow can be stored.

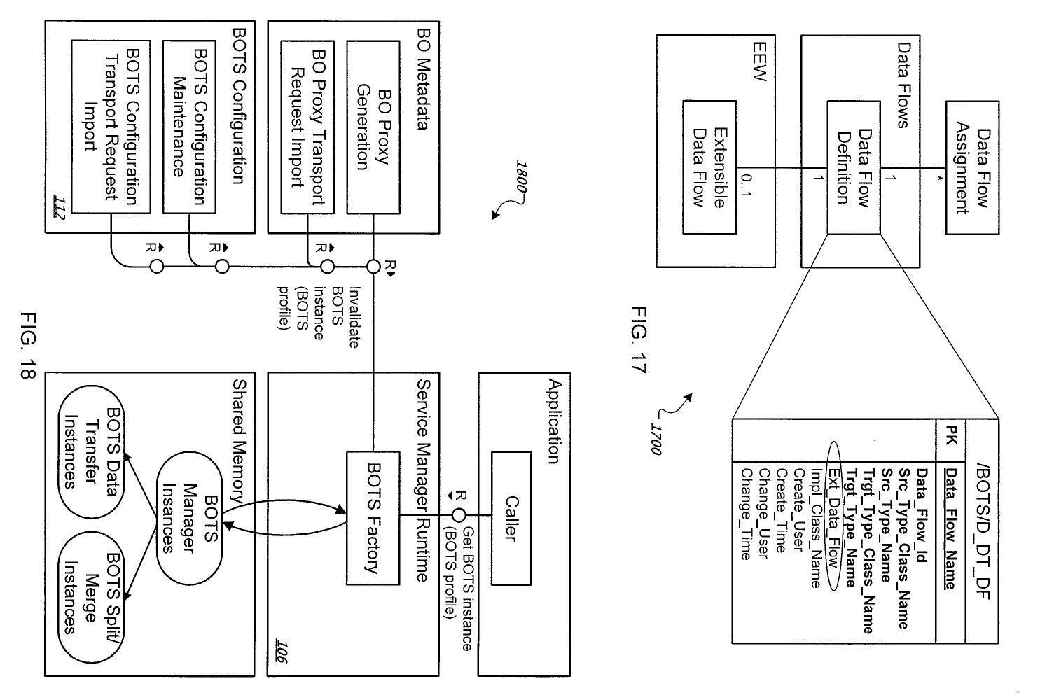

FIG. 18 shows an exemplary block diagram 1800 of buffering in a transition service for business objects. For example, the diagram 1800 can illustrate how to buffer data that is read when calling the instantiation. The diagram 1800 can use at least part of the management service 106, such as a runtime thereof. The diagram 1800 can use the configuration 112. In BOTS implementations, a BOTS buffer management can be used (pages 111 et seq.).

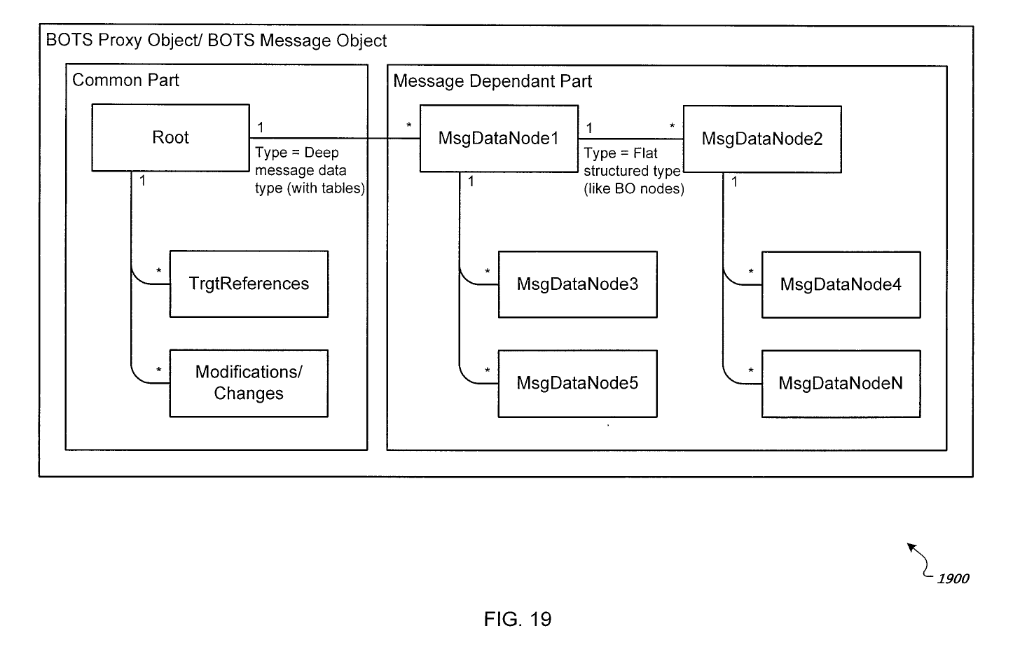

FIG. 19 shows an exemplary business object 1900 for a container of a transition service for business objects. Foe example, the object 1900 can be the same as, or equivalent to, the message object (MO) mentioned above. The object can have a root and one or more nodes. The object 1900 can be used to provide messaging relating to a transition service. For example, the object 1900 can be used as a structure for organizing message data.

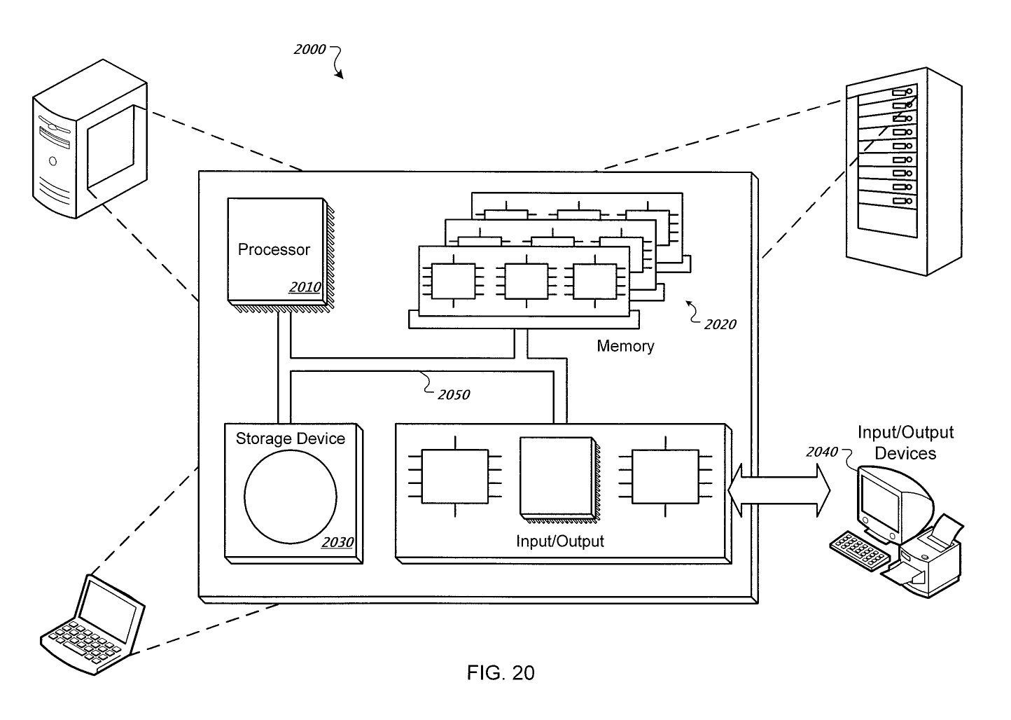

FIG. 20 is a schematic diagram of a generic computer system 2000. The system 2000 can be used for the operations described in association with any of the computer-implement methods described previously, according to one implementation. The system 2000 includes a processor 2010, a memory 2020, a storage device 2030, and an input/output device 2040. Each of the components 2010, 2020, 2030, and 2040 are interconnected using a system bus 2050. The processor 2010 is capable of processing instructions for execution within the system 2000. In one implementation, the processor 2010 is a single-threaded processor. In another implementation, the processor 2010 is a multi-threaded processor. The processor 2010 is capable of processing instructions stored in the memory 2020 or on the storage device 2030 to display graphical information for a user interface on the input/output device 2040.

The memory 2020 stores information within the system 2000. In one implementation, the memory 2020 is a computer-readable medium. In one implementation, the memory 2020 is a volatile memory unit. In another implementation, the memory 2020 is a non-volatile memory unit.

The storage device 2030 is capable of providing mass storage for the system 2000. In one implementation, the storage device 2030 is a computer-readable medium. In various different implementations, the storage device 2030 may be a floppy disk device, a hard disk device, an optical disk device, or a tape device.

The input/output device 2040 provides input/output operations for the system 2000. In one implementation, the input/output device 2040 includes a keyboard and/or pointing device. In another implementation, the input/output device 2040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A data flow entity tangibly implemented in a computer-readable storage medium, the data flow entity comprising:
information identifying at least one preceding object instance in a business process;
information defining at least one succeeding object instance in the business process; and
information identifying at least one processing entity configured to be invoked in association with execution of the data flow entity;
wherein the data flow entity encapsulates substantially all aspects of a flow of data from a data structure that is at least part of the preceding object instance into a data structure that is at least part of the succeeding object instance.

2. A computer-implemented method comprising:
modeling all aspects of a flow of data from at least one preceding object instance to at least one succeeding object instance, the modeling performed using at least one data flow entity.

3. A transaction service for interacting with business objects, the transaction service tangibly implemented in a computer-readable storage medium and comprising:
a management service;
a splitting and/or merging service; and
a data transfer service.
